(19) United States
(12) Patent Application Publication
(10) Pub. No.: US 2007/0238508 A1
(43) Pub. Date: Oct. 11, 2007

(54) Slot machine

(76) Inventors: Ward W. Chilton, Reno, NV (US); Shawn Michael Van Asdale, Reno, NV (US)

Correspondence Address: Shawn Van Asdale, 2573 Rampart Terrace, Reno, NV, 89509, US

(21) Appl. No.: 11/370,471

(22) Filed: Mar. 8, 2006

(51) Int. Cl. A63F 13/00

(52) U.S. Cl. 463/20

(57) ABSTRACT

The present invention relates to a gaming machine capable of playing a large number of games from a game library stored in an associated memory. The gaming machine overcomes prior inefficiencies by allowing the player to enter desired search criterion and thereby filter the number of available games to a manageable size from which to choose. The search criterion may be made up of a word or words entered by the player and/or the player may limit the search by selecting one of a variety of pre-defined limitations. Preferably the search criterion is compared to a database reflecting the games available in the game library. The game library may be maintained by a central game server that is connected to the gaming machine (and others like it) over a network.

### BACKGROUND OF THE INVENTION

The present invention relates generally to a gaming system employing a plurality of gaming terminals where the gaming terminals are capable of playing one of several games stored in a vast game library preferably on a central game server. More particularly, the present invention provides a new and improved method for a player to select which game to play from the library of available games. Gaming terminals are devices which upon a player making a wager, the player may win an award. Gaming terminals include machines more commonly referred to as slot machines and video lottery terminals. There are many types of games that can be played on these gaming devices including but not limited to slots, video poker, keno, bingo, pachinko and blackjack.

Conventional gaming terminals or gaming machines typically have a cabinet and a gaming display mounted inside the cabinet. The gaming display may be mechanical, such as a series of stepper reels that carry gaming symbols on the reels, or may be electronic such as a video display that is capable of generating video images of gaming symbols. Whether mechanical or electronic, the gaming display may be capable of generating images associated with a game, such as poker, blackjack, slots, keno, pachinko or bingo. The gaming machine is controlled by a processor with an associated memory.

The gaming machine is configured for a player to input something of value used to make a wager, which can include a standard denomination of currency, a ticket, and/or any other representation of currency or credit. Once the player inputs a wager, the player may then activate the device. Upon activation, in the case of a slot machine, a plurality of reels which are either mechanical or represented on the video screen spin and ultimately stop to display a random combination of some form of symbol, for example, numbers or symbols. If the display contains one of a plurality of winning combinations, the machine issues an award. The amount of award will typically depend on the winning combination that is achieved. The gaming machine then either releases money into a payout chute, issues a ticket, issues credits onto a credit meter, or indicates and awards the winning amount to the player in any suitable manner. Often the award amount is related to the initial amount wagered.

Similarly, with respect to video poker, once a player inputs a wager, a number of cards is displayed and ultimately the player's poker hand ranking is evaluated. With respect to other types of gaming devices discussed above, the appropriate display is shown to the player upon activation of the gaming device and awards are given based on the specific rules of each game. Regardless of whether the gaming machine is displaying reels, or cards or a keno game, the activation of the game will generally be referred to herein as a spin.

Gaming machines that use a video display to display the game can easily be reprogrammed to display a different game or even a different game type by accessing a different program in the memory. For instance, it is a simple matter to change a video slot game into a video poker game—only the program being run by the processor of the gaming machine needs to be changed. Additionally, recent advances in technology now allow machines that use mechanical stepper motors to drive physical reels to change the symbols displayed on the reels via programming and therefore change the game being displayed.

For several years, gaming machines using a video display have stored a number of games, sometimes as many as ten, on internal EPROMs. EPROMs provided a level of inherent security for the gaming machine because the data stored on the EPROM could not easily be changed. However, the storage capacity of EPROMs is very limited. Therefore, in order to store up to ten games, the graphics and sounds used for the games were generally simpler and less attractive than the games on gaming machines storing only a single game program. As encryption and authentication methods have become more sophisticated however, gaming regulators have approved the use of mass storage devices such as hard drives for use in gaming machines. Gaming machines equipped with such hard drives could store literally hundreds of simple games on a single hard drive. Further, by connecting such a gaming machine to a networked system, the gaming machine could download from a central server a single “complex” game from a library of hundreds or even thousands of such games.

Obviously, when the gaming machine used EPROMs to store ten or fewer games, it was a relatively simple matter for the player to select which of the stored games he wished to play. Typically, the gaming machine would display ten icons, one corresponding to each available game, and the player would pick the desired game by selecting the associated icon. When the number of available games is far greater in number than ten, this system is inefficient and will largely result in the player wasting valuable time looking for a game to his liking. Additionally, the player may get frustrated and leave a machine if he cannot find his desired game. The present invention overcomes the shortcomings of the prior art method for game selection.

### SUMMARY OF THE INVENTION

In the present invention the player is provided an improved and new method of selecting one game from a library of several games that are available for play on a gaming machine. This is accomplished by first developing a database based on the library of available games. The database and/or the library of available games may be stored on the gaming machine, but preferably both the library and the database are stored on a central server that may be accessed by the gaming machine via a network. The database includes such things as the game type, the game's title, descriptive words associated with the game, general information about the game, such as the number of lines, reel layout, denomination, bonus game types, and may include mathematical information about the game such as bonus game frequency, jackpot frequency, hit frequency and volatility. The player may enter a search term or terms that will be compared to the database to display to the player a list of the available games that match the search term(s). Preferably the search term is entered by the player using a full-size QWERTY keyboard displayed on the video display of the gaming machine coupled to a touch screen. Alternatively, an auxiliary screen, such as a screen used for a player tracking system interface may be used. The player's search may also be limited using pre-defined search-limiting items preferably comprising some of the available general and/or mathematical information.

In addition, the improved method of game selection may be performed at a location remote from the gaming machine to be used. For instance, the player may use a specialized kiosk provided by the casino to access the database of available games. The casino may even allow players to access its database of available games over the Internet. In which case, the player can chose a game at home to play on a future trip to a specific casino. When the database is accessed remotely rather than from a gaming machine, the game selected by the player may be associated with a player's player ID number stored on the player's player tracking card such that when the player inserts his card into a gaming machine capable of playing the selected game, that game is automatically loaded for play. Alternatively, the player may be provided with a ticket that, upon insertion into a gaming machine, will load the desired game.

### BRIEF DESCRIPTION OF THE DRAWINGS

FIG. 1 is a front perspective view of a gaming machine that may be used to employ the present invention.

FIG. 2 is a schematic diagram of the electronic configuration of an embodiment of the gaming device of the present invention.

FIG. 3 is a schematic diagram of a network with a plurality of gaming machines and a central gaming server that may be used to employ the present invention.

FIG. 4 is a screen shot of a gaming machine employing the present invention to search a database for a library of available games.

FIG. 5 is a screen shot of a gaming machine employing the present invention to display available games that correspond to the search entered in FIG. 4.

### DETAILED DESCRIPTION OF THE INVENTION

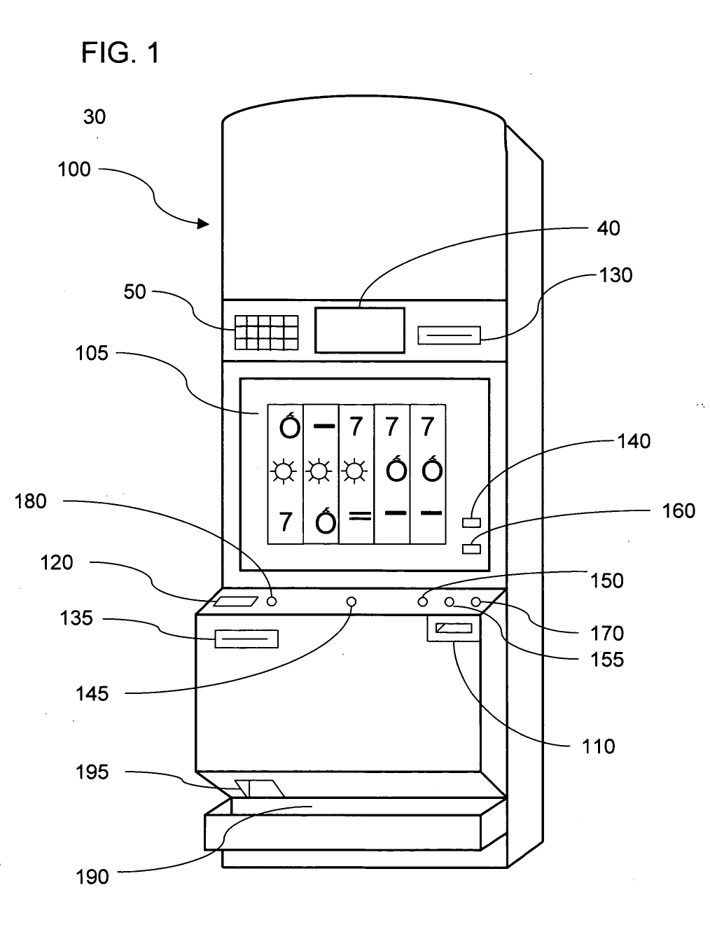

One embodiment of the present invention may be deployed on a gaming machine or gaming device 100 as illustrated in FIG. 1. Gaming machine 100 has the features of a conventional slot machine. The gaming machine 100 shown in FIG. 1 is what is commonly referred to as an upright slot machine and the player can operate it while standing or sitting. Most often the gaming machine 100 is preferably mounted on a cabinet. (Not shown.) Although an up-right slot machine 100 is shown in FIG. 1, it can be appreciated that the gaming machine 100 can be any other style of gaming machine known in the art including, but not limited to a pub-style table-top or slant-top game which a player can operate while sitting. The gaming machine 100 can be constructed with varying cabinet and display designs.

Gaming machine 100 can incorporate a variety of game types including, but not limited to slots, video poker, blackjack, keno or bingo. The symbols used on and in gaming machine 100 may be displayed in mechanical, electrical, electronic or video form. Gaming machine 100 shown in FIG. 1 has a video display 105 for displaying symbols.

It should be appreciated that the display devices may display any visual representation or exhibition, including but not limited to video images or movement of physical objects such as mechanical reels and wheels. The display devices can be a video monitor or screen, a liquid crystal display or any other display mechanism. Furthermore, it should be appreciated that these display devices may preferably include touchscreens.

As shown in FIG. 1, gaming machine 100 preferably includes one or more value accepting mechanisms. The primary value accepting mechanism on the gaming machine 100 shown in FIG. 1 may be a bill validator 110. The bill validator 110 may also accept other forms of payment including, but not limited to tickets, smart cards, debit cards and credit cards. Alternatively, some of these forms of payment may be accepted through a card reader 130. The card reader 130 may include any type of card reading device, such as a magnetic card reader or an optical card reader. The player will insert a card, such as a player tracking card or a credit card into the card reader 130 which will then read data from the card. The card reader 130 may be used to read and/or write from and/or to the inserted card. There is also a coin slot 120 on the gaming machine 100 in which a player can insert coins or tokens.

After a player inserts money in the gaming machine 100, either via the coin slot 120, the bill validator 110 or the card reader 130, or other means a number of credits corresponding to the amount deposited is shown in a credit display 140. After money is credited to the machine 100 and shown on the credit display 140, the player then determines the wager amount. The machine 100 may have any number of mechanisms known in the art for allowing a player to determine his wager. For example, in the case of a multi-line slot game as shown in FIG. 1, the player may determine the amount of paylines he wishes to wager on by pushing a bet one line button 155 a number of times corresponding to the number of paylines he wishes to bet. Then the player may determine the wager amount per payline by pushing a bet one credit button 170 an appropriate number of times. The product is the player's total wager. As the player is selecting the wager amount, this wager amount is displayed on a bet display 160. As the bet display 160 amount is incrementing, the credit meter 140 amount is decreasing by the corresponding amount.

Although FIG. 1 displays a five reel video slot machine with three rows of symbols, it can be appreciated that any configuration of video or mechanical reels can be used in the gaming machine 100 according to the invention as well as any corresponding number of paylines as known in the art. Each reel often displays symbols. The symbols may include cherries, sevens, bars and the like traditionally used on slot machines or any other symbol created by the manufacturer. The specific display of the symbols after each play determine the payout, if any made by the gaming machine 100.

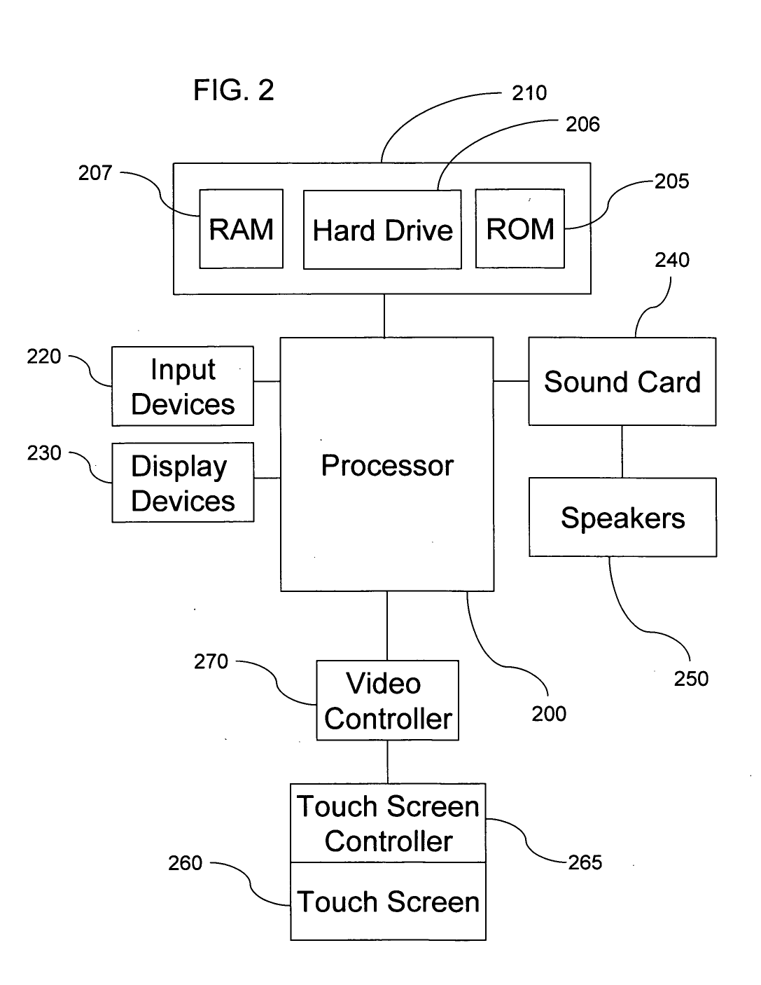

FIG. 2 is a block diagram of the general electronic configuration that may be incorporated in the gaming machine 100. The configuration preferably includes a processor 200. The processor 200 is preferably a microcontroller-based platform or microprocessor which is capable of displaying images, symbols and other symbol such as images of people, characters, places, things and faces of cards. One or more secondary processors may also be employed in conjunction with the primary processor 200 to control certain aspects of the game function.

The gaming machine 100 also includes a memory device 210 for storing program code or other data. This memory device 210 can include both read only memory (ROM) 205 and random access memory (RAM) 207 and preferably includes a mass storage device that can be written to in situ, such as a hard drive 206. In addition to the memory device 210, the electronic configuration of the gaming machine 100 may also include one or more input devices 220, one or more display devices 230, a sound card 240, and one or more speakers 250.

The input devices 220 may include but are not limited to a primary spin button 145, a bet one credit button 170, a max bet button 150, a cash out button 180 and a bet one line button 155. In situations where a touch screen 260 is used, a touch screen controller 265 and touch screen 260 are connected to a video controller 270 and the processor 200.

Although FIG. 2 shows the processor 200 and memory device 210 residing on the gaming machine 100, it should be appreciated that it is possible for both the processor 200 and memory device 210 to reside at a central location instead of at the gaming machine 100. In such a situation, a network server may be used to communicate to the gaming machine over an Internet connection, local area network (LAN), or wide area network (WAN). The processor 200 and memory device 210 are generally referred to herein as the controller.

Once the player has finalized his wager amount, the player may initiate play by pressing the primary spin button 145. In response to play initiation, the gaming machine 100 randomly displays a plurality of symbols on the video display 105. In the video configuration of the gaming machine 100 shown in FIG. 1, the symbols are displayed by simulating the spinning of the video reels as is known in the art. As used herein, “reels ” will thus include both mechanical and video reels unless one type is specifically referenced. The processor 200 evaluates the displayed symbols on the selected paylines to determine if any winning combinations occurred. For each winning combination the credit meter 140 is incremented a predetermined amount.

In the preferred operation of the gaming machine, when a player no longer wishes to play, he activates the cash out button 180, which results in any amount on the credit meter 140 being paid to the player either by crediting a player's account, issuing a ticket by a ticket printer 135 or by depositing coins or tokens into a coin tray 190 through a coin chute 195.

The gaming machine 100 may also include an auxiliary video screen such as a player tracking screen 40 and an associated player tracking keyboard 50. These devices may be associated with the card reader 130.

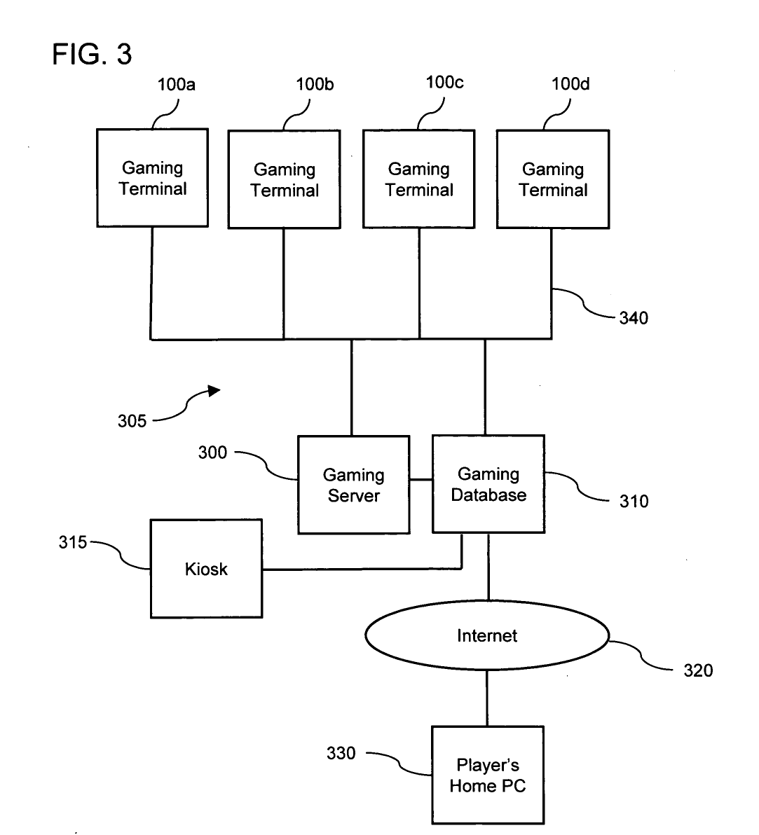

Referring now to FIG. 3, a gaming system 305 with a number of gaming machines 100a, 100b, 100c and 100d operatively connected to a central gaming server 300 by a network connection 340 is shown. The central gaming server 300 is also operatively connected to a gaming database 310. The central gaming server 300 preferably has an associated memory such as one or more hard drives and/or one or more associated memory devices such as DVDs, CDs or the like. The central gaming server 300 preferably maintains a library of game programs on its accessible memory that may be downloaded to the gaming machines 100a, 100b, 100c and 100d. The gaming database 310 may in fact be stored in the gaming server 300 or may merely be operatively connected to the gaming server 300. Additionally, the gaming database 310 may be connected to the Internet 320, such that a player may access the gaming database 310 using a personal computer 330. The gaming database 310, may also be accessed by a kiosk 315. Preferably, the gaming machines 100a, 100b, 100c and 100d, the gaming server 300 and the kiosk 315 are all located on a single casino property. However, the gaming machines 100a, 100b, 100c and 100d may be located on several different casino properties and the gaming server 300 may be located at a secure location controlled by either the game maker, a casino or a state gaming control agency.

In the alternative embodiment where each gaming machine 100 stores a library of games in its memory 210 and there is no network connection 340 to a central server 300. The memory 210 of each gaming device 100 will also store a database 310 corresponding to the games on the specific memory 210.

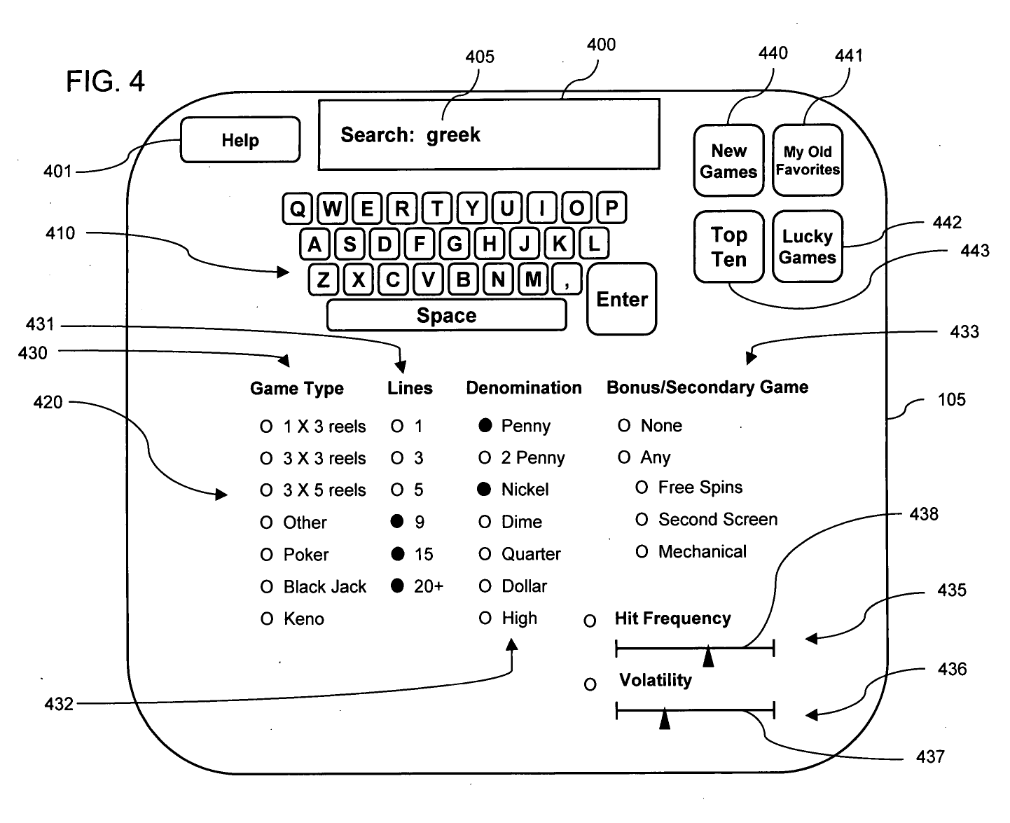

Referring now to FIG. 4, the use of the present invention will now be described in greater detail. FIG. 4 shows the video display 105 of a gaming machine 100. The display has three main areas. First, there is a search bar 400. Where one or more search terms may be displayed. On the example shown, the player has entered a search term 405 of “greek.” This search term 405 was entered using the second area on the video display 105, a touch-screen operable keyboard 410. Preferably, the keyboard 410 is a full size QWERTY key board displayed on the video display 105. The touch screen 260 allows the player to use the key board 410 to enter search terms into the search bar 400. The third section in the preferred embodiment is a pre-defined limitations section 420, that the player may use to further limit his search. The pre-defined limitations section 420 may use drop down type menus, but more preferably, it will allow a player to select multiple limitations from a variety of categories. For instance, the pre-defined limitations section 420 shown allows a player to further limit his search by a “Game Type” category 430, a number of “Lines” category 431, a “Denomination” category 432, and a “Bonus/Secondary Game” category 433. Additionally, the pre-defined limitations section 420 includes a “Hit Frequency” category 435 and a “Volatility” category 436. These categories relate to the specific mathematical qualities of the games in the library. Because these two mathematical qualities may be nearly infinite in variation, a pair of slider bars 437 and 438 may be used to relatively select a game with a high or low hit frequency. Alternatively, a player may enter a specific value for a desired hit frequency, e.g., 50%.

In addition to using search phrases and pre-defined limitations to locate a desired game or list of possible games, the gaming system 305 may provide the player the option of selecting from a pre-arranged group of games. For instance, if the player activates the “New Games” button 440 shown on FIG. 4, the player may be presented with a list of the ten games most recently added to the game library. While if the user selects the “My Old Favorites” button 441, the player may be presented with a list of the five games the player has played most frequently in the past year. Such information may be tracked using the player's tracking card and stored either locally at an individual casino or at a central site accessible by multiple casinos. Additionally, if the player selects the “Top Ten” button 443, the ten most popular games in the game library, as determined by the playing public, may be displayed. Finally, if the player selects the “Lucky Games” button 443, the player may be presented with, for instance, the ten games that on this particular day have hit the most jackpots. This would allow the player to make sure he is always playing what is perceived as the “hot” or “loose” game. Of course, these are just a few of the pre-arranged group of games that may be offered at the player's request.

Also shown on FIG. 4 is a “Help” button 401. Activating the Help button 401 may take the player to a second screen where the various features of the gaming system 305 may be explained. Also, this section may contain information that will be useful to the novice player such as definitions for terms like Hit Frequency that may be well understood by those familiar with the industry as well as by experienced slot players.

As is evident on FIG. 4, the exemplar player has entered a search term 405 of “greek” using the keyboard 410 and has further limited the search using the pre-defined limitations section 420. Specifically, the player has requested games with nine, fifteen or twenty or more lines using the “Lines” category 431 and has requested penny and nickel denomination games using the “Denomination” category 432. In operation, these search term(s)/limitations may be communicated to the gaming server 300 via the network connection 340. The gaming server 300 may then compare the search terms and limitations against the database 310. Once the gaming system 305 determines the games in the library that match the search terms and limitations, the gaming server 300 communicates the results to the requesting gaming machine 100.

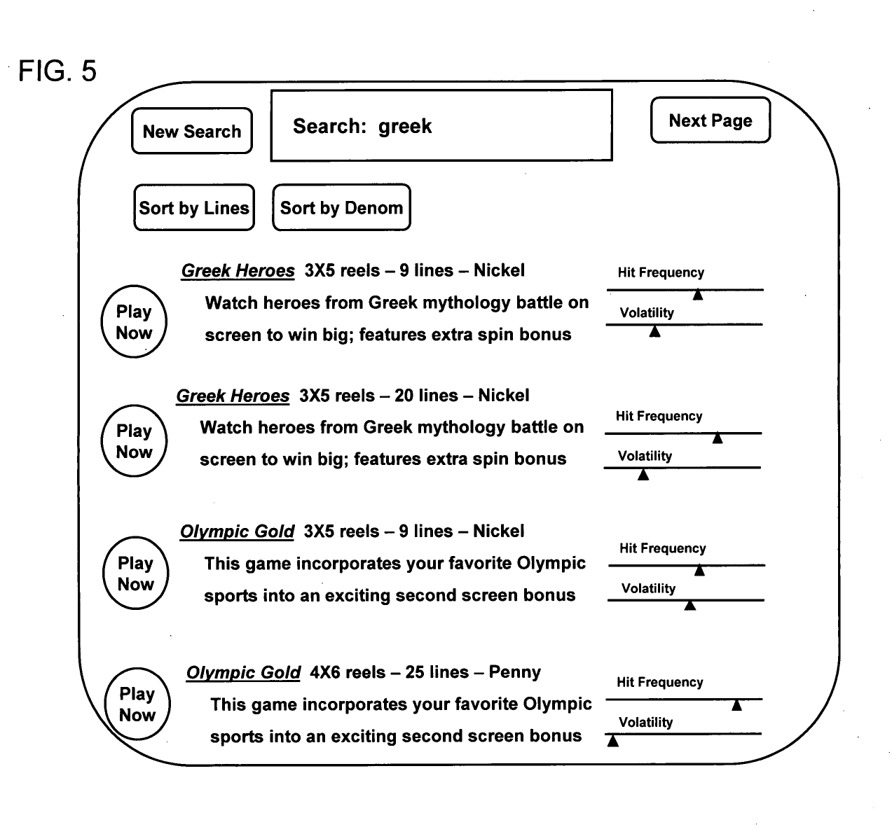

The results for the exemplar search are shown on FIG. 5. FIG. 5 shows a plurality of descriptions 501, 502, 503 and 504 for four games that match the search criterion. Each game description shown includes the name of the game along with general information describing the reel layout, maximum number of lines played and denomination. The description also includes a brief description of the game theme, which may include information about any available bonuses or other features. Also included in the description is a graphical representation of some of the game's mathematical properties, specifically hit frequency and volatility. Other information may be included and some of the information shown may not be included in various embodiments of the present invention.

It should be appreciated by those familiar with gaming machines that the description 501 for the game “Greek Heroes” differs from the description 502 for a game of the same name. One noted difference is that the first description 501 is for a nine-line game, while the second description 502 is for a twenty line game. Although these are shown as two different entries, in other embodiments, the gaming system 305 may be configured to display games of the same title as a single entry. The player may then select the entry and be presented with a sub-screen where he chooses between, for instance, the nine-line and twenty-line versions. Each description 501, 502, 503 and 504 in FIG. 5 has a corresponding touch-screen “Play Now” button 601, 602, 603 and 604 that the player may activate to play the associated game. Alternatively, the player may just tap the description corresponding to the desired game to initiate play. Play initiation may require that the game program be downloaded from the central server 300 to the gaming machine 100 in order for the game to be played. Or, if the program for the selected game is already stored in the memory 210 of the gaming machine 100, play may begin immediately.

It should be appreciated that the last two game descriptions 503 and 504 shown on FIG. 5 do not have the word “greek” in either the title or the description of the game. However, because both game descriptions 503 and 504 involve game themes involving the Olympic Games, the game database 310 may have associated the word “Greek” and/or “Greece” with the games. Thus the search returned these two game descriptions 503 and 504 as matches to the search term.

Although it is preferable that the games in the game library are represented in a corresponding database of games, it would be possible for the same information stored in the database to be directly stored in the game programs themselves. Thus, in response to a search query, the gaming server 300 may search the game programs in its library rather than the corresponding database.

While this invention has been described with respect to several specific embodiments thereof, it should be understood that the invention is not limited to the disclosed embodiments, but rather that the invention is intended to cover various combinations, modifications and equivalent arrangements which will be apparent to those skilled in the art. It is thus to be understood that the invention should not be limited by the description, and that modifications and variations in the present invention may be made without departing from the novel aspects of this invention as defined in the following claims.

1. A gaming machine comprising:
a cabinet;
a processor with an associated memory, said memory storing a plurality of game programs, and said processor capable of executing said game programs;
a value accepting mechanism;
a payout mechanism;
a wagering device for allowing a player to make a wager on the outcome of a spin of a game program;
a video display device incorporating a touch screen;
said gaming machine being programmed to allow a player to enter a search criterion comprising a search term and/or a pre-defined limitation by displaying a QWERTY keyboard on the video display so that a player may touch said keyboard and enter a search term and by displaying at least one player selectable pre-defined limitation, where the at least one player selectable pre-defined limitation includes either a game type, a number of lines or a denomination;
said gaming machine being further programmed to compare the search criterion with the plurality of game programs stored in the associated memory and to determine if the search criterion relates to any of the game programs, and, for each such related game program, said gaming machine being programmed to indicate to the player the existence of said related game program and to allow the player the option of executing said game program such that the player may wager on the outcome of a spin of said executed game program.

2. A gaming machine as defined in claim 1 wherein a database is stored in a second associated memory and the database comprises a plurality of entries and each of said entries correspond to one of the game programs stored in the first associated memory and each of said entries includes at least a game title, a group of words associated with said game title, and information about the characteristics of a game program.

3. A gaming machine as defined in claim 2 wherein the gaming machine compares the search criterion to the database to determine if the search criterion relates to any of the game programs.

4. A gaming machine as defined in claim 1 wherein the first associated memory is housed in a central gaming server connected to the gaming machine by a network.

5. A gaming machine as defined in claim 3 wherein the first associated memory is housed in a central gaming server connected to the gaming machine by a network.

6. A gaming machine as defined in claim 4 wherein the gaming machine further comprises a third associated memory located inside the cabinet operatively connected to the processor and after a player has selected a game program, the game program is downloaded from the first associated memory to the third associated memory.

7. A gaming machine as defined in claim 5 wherein the gaming machine further comprises a third associated memory located inside the cabinet operatively connected to the processor and after a player has selected a game program, the game program is downloaded from the first associated memory to the third associated memory.

8. A gaming machine as defined in claim 4 wherein the central gaming server houses the first associated memory and second associated memory on a single memory storage device.

9. A gaming system comprising:
a central gaming server with a first memory for storing a plurality of game programs;
a searchable gaming database comprising a plurality of entries corresponding to at least a portion of said game programs;
a plurality of gaming machines operatively connected by a network to the central gaming server and the gaming database, each of said gaming machines comprising a cabinet, a processor capable of executing at least one of said game programs, a value accepting mechanism comprising at least one of either a ticket reader, bill validator or card reader, a payout mechanism, a wagering device for allowing a player to make a wager on the outcome of a spin of the at least one game program, and a display device for displaying the outcome of the at least one game program;
each of said gaming machines allowing a player to enter a search criterion, said search criterion being compared to the entries in the database;
said gaming machine on which said search criterion was entered being programmed to display to the player a visual indication of the game programs corresponding to the entries which satisfy the search criterion, and being further programmed to allow the player to select at least one of said satisfying game programs, said gaming machine, in conjunction with the central gaming server, being further programmed to execute a selected game program such that the player may play the selected game program at said gaming machine.

10. A gaming system as defined in claim 9 wherein each of said gaming machines has a second memory associated with the gaming machine processor and in order to play a selected game program at least a portion of said game program is downloaded from the first memory to the second memory.

11. A gaming system as defined in claim 10 wherein in order to play a selected game program all of said game program is downloaded from the first memory to the second memory.

12. A gaming system as defined in claim 9 wherein the display device is a video display.

13. A gaming system as defined in claim 12 wherein each of said gaming machines comprises a touch screen operatively connected to said video display and said gaming machines are programmed to display on said video display a keyboard such that by touching said keyboard a player may enter at least one search term to be used as at least a portion of the search criterion.

14. A gaming system as defined in claim 13 wherein in addition to a player entered search term, the search criterion may include at least one pre-defined limitation selected by the player.

15. A gaming system as defined in claim 14 wherein the at least one pre-defined limitation is selected from either general information or mathematical information about a game program.

16. A gaming system as defined in claim 15 wherein the pre-defined limitations related to general information is at least one of a game's reel layout, maximum number of pay lines or denomination.
